(19) United States
(12) Patent Application Publication
(10) Pub. No.: US 2007/0232386 A1
(43) Pub. Date: Oct. 4, 2007

(54) GAMING MACHINE ALLOWING USE OF TWO TYPES OF CREDITS

(75) Inventor: Toshiyuki YOSHIMURA, Zama city (JP)

Correspondence Address: GLOBAL IP COUNSELORS, LLP, 1233 20TH STREET, NW, SUITE 700, WASHINGTON, DC, 20036-2680, US

(73) Assignee: KONAMI GAMING INCORPORATED, Las Vegas, NV (US)

(21) Appl. No.: 11/690,853

(22) Filed: Mar. 26, 2007

(30) Foreign Application Priority Data
Mar. 28, 2006 (JP) 2006-086877

(51) Int. Cl. A63F 13/00

(52) U.S. Cl. 463/25

(57) ABSTRACT

In a gaming machine of the present invention, a memory unit stores main and sub-credit data. The console unit accepts first or second bet data. The controller unit executes first and second game program when the console unit has accepted the first and second bet data, respectively. The controller unit determines whether or not to provide the player with an amount of credits in first and second games conducted by the first and second game programs, respectively. The credit processing unit updates the main and sub-credit data to reduce an amount of credits by an amount of a bet represented by the first and second bet data, respectively. The credit processing unit further updates the sub-credit data to increase an amount of credits by a predetermined amount each time the controller unit determines to provide an amount of credits in the first game.

### BACKGROUND OF THE INVENTION

1. Field of the Invention

The present invention relates to a gaming machine that is installed in a casino or the like.

2. Background Information

Before game play on a gaming machine installed in a casino or the like, a player first inserts his or her own money into the gaming machine. The gaming machine then counts the money and stores credit data representing the count as an amount of credits into a specific memory area. The gaming machine allows the player to use the credits stored in the memory area as a bet to be placed on a game. The gaming machine determines whether or not the player wins a game, and how large an award will be provided to the winning player, on the basis of the bet and the result of the game. The gaming machine further updates the credit data to increase or decrease the amount of the credits by the amount of the award or the bet when the player has won or lost the game, respectively. Some players limit the amount of a bet per game to a small one, and thereby try to enjoy game play as many times as possible within a limited amount of credits. This type of players in general is much more likely to avoid a more risky game in order to save his/her credits, even if there is an opportunity to gain a much larger amount of an award.

A gaming machine is known which helps a player save his/her credits (cf. Japan Published Patent Application No. 2004-305526). The gaming machine comprises a main memory and a sub-memory, and uses them to store two types of credit data. When a player starts a game on the gaming machine, the player first inserts his or her own money into the gaming machine. The gaming machine then counts the money and stores main credit data representing the count into the main memory. The gaming machine allows the player to use the credits stored in the main memory as a bet to be placed on a game. If the player wins a game, the gaming machine updates not only the main credit data stored in the main memory, but also sub-credit data stored in the sub-memory to increase the respective amounts of the credits. Here, the amount of credits represented by the sub-credit data is increased by a percentage of the amount of an award, and the amount of credits represented by the main credit data is increased by the remainder of the award. The gaming machine prohibits the use of the sub-credit data in game play, but only allows conversion of the sub-credit data into cash. Accordingly, if the player uses up the credits represented by the main credit data, the credits represented by the sub-credit data still remain. This protects players from using all the money in their possession.

Some players avoid playing high-risk games on conventional gaming machines for fear of losing all the money in their possession. This prevents the gaming machines from enhancing the players' willingness to play games. On the other hand, the gaming machine storing the two types of credit data described above disables a portion of players' credits for use as bets, and thereby may reduce the players' fear of losing all their money. However, the gaming machine also cannot induce players to enjoy high-risk games, since a larger amount of a bet per high-risk game still reduces the possible number of game plays.

In view of the above, it will be apparent to those skilled in the art from this disclosure that there exists a need for an improved gaming machine that induces players to enjoy high-risk games without the fear of losing all the money in their possession and a reduction in the possible number of game plays, and thereby enhances the players' willingness to play games. This invention addresses this need in the art as well as other needs, which will become apparent to those skilled in the art from this disclosure.

### SUMMARY OF THE INVENTION

A gaming machine according to the present invention comprises a memory unit, a console unit, a controller unit, a display unit, and a credit processing unit. The memory unit is configured to store main credit data and sub-credit data. The console unit is configured to allow a player to enter one of first bet data and second bet data therein. The first bet data and the second bet data each represent an amount of a bet placed by the player. The controller unit is configured to execute a first game program and a second game program when the console unit has accepted the first bet data and the second bet data, respectively. The controller unit is also configured to determine whether or not to provide the player with an amount of credits as a result of a first game and a second game conducted by the first game program and the second game program, respectively. The display unit is configured to display the main credit data, the sub-credit data, and a game screen, depending on the status of the first game and the second game. The credit processing unit is configured to update the main credit data and the sub-credit data to reduce the amount of credits by the amount of a bet represented by the first bet data and the second bet data before the controller unit starts the first game and the second game, respectively. The credit processing unit is further configured to update the sub-credit data to increase the amount of credits by a predetermined amount each time the controller unit decides to provide an amount of credits as a result of the first game.

As described above, the gaming machine of the present invention allows a player to play the second game when the amount of credits represented by the sub-credit data reaches a predetermined value. Here, the amount of credits represented by the sub-credit data originates not in the money that the player has inserted in advance, but rather in a portion of the awards won as a result of the first games. This may reduce the player's fear of losing all his or her money in the second game, and thereby cause the player to feel free to play the second game. Thus, the gaming machine may induce the player to play the second game, even if the second game is more risky than the first game.

The credit processing unit is preferably configured to disable the shift of a portion of or all of the credits represented by the main credit data to credits represented by the sub-credit data, and thereby inhibit the use of credits represented by the main credit data as a bet in the second game. The player who wants to play the second game has to win the first game many times, and thereby increase the credits represented by the sub-credit data. Thus, the gaming machine can induce players who want to play the second game only to play the first game, and thereby provide them with opportunities to enjoy more various games.

The console unit is preferably configured to accept second bet data independent of the status of the first game. In that case, the controller unit is preferably configured to change the first game program in midstream to the second game program when the console unit has accepted the second bet data in the period of the first game. In particular, an entry of second bet data may automatically change the first game to the second game. Thus, the gaming machine can continuously attract players.

The credit processing unit is preferably configured to update the main credit data to increase the amount of credits by a predetermined amount each time the controller unit decides to provide an amount of credits as a result of the second game. In this case, a player can play the second game in order to increase the credits represented by the main credit data. Thus, the player can balance credits between the main credit data and the sub-credit data, and thereby enjoy the first and second games in balance.

The credit processing unit is preferably configured to update the sub-credit data to increase the amount of credits by a predetermined amount each time the controller unit decides to provide an amount of credits as a result of the second game. In this case, the amount of the credits represented by the sub-credit data is the total number of credits won as awards in the first and second games. Thus, the credits represented by the sub-credit data are easy to increase. This allows the gaming machine to induce players to play the second game, even if it is more risky than the first game.

The console unit is preferably configured to accept an instruction from a player to shift a portion of or all of the credits represented by the sub-credit data to credits represented by the main credit data. In this case, the credit processing unit is configured to update the sub-credit data to reduce the amount of credits by an amount represented by the instruction that the console unit has accepted, and update the main credit data to increase the amount of credits by the amount represented by the instruction. Thus, a player can play the first game even if he/she uses up the credits represented by the main credit data. In particular, the gaming machine requires the player only to enter a command for a shift of credits from the sub-credit data to the main credit data, in contrast to conventional gaming machines. This facilitates the shift, and thereby enhances the players' willingness to play games on the gaming machine.

The gaming machine preferably sets the payout percentage of the second game to be 100%. Here, the payout percentage determines the profits earned by an owner of a gaming machine, i.e., a higher payout percentage provides the owner with a smaller profit on average. Accordingly, a player who plays the second game on the gaming machine of the present invention provides the owner of the gaming machine with no profit on average. In other words, the player can recover all of the credits used in the second games on average. This reduces the risk of playing the second games, and thus the gaming machine can induce players to play the second game, even if the second game is more risky than the first game.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a portion of this original disclosure:

FIG. 1 is a flow chart of a round of a double up game on a slot machine according to an embodiment of the present invention;

FIG. 2 is a perspective view of the appearance of the slot machine according to the embodiment of the present invention;

FIG. 3 is a block diagram of the hardware configuration of a main controller unit included in the slot machine shown in FIG. 2;

FIG. 4 is a block diagram of the hardware configuration of a sub-controller unit included in the slot machine shown in FIG. 2; and

FIG. 5 is a flow chart of a round of a slot game on the slot machine shown in FIG. 2.

### DETAILED DESCRIPTION OF THE PREFERRED EMBODIMENT

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

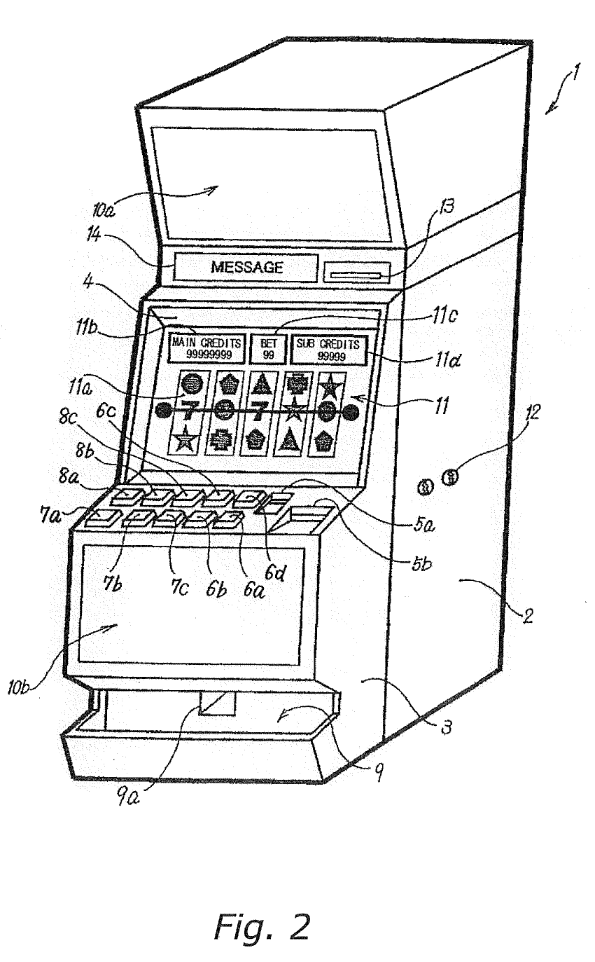

A preferred embodiment of the present invention is a video slot machine preferably installed in a casino. At first, the basic configuration of the slot machine will be described below. As shown in FIG. 2, the slot machine 1 comprises a box-shaped cabinet 2, and a front panel 3 that is coupled to the front of the cabinet 2 so as to allow the cabinet 2 to be opened and closed. On the front panel 3 are provided, for example, a display window 4, a coin slot 5a, a bill slot 5b, a spin button 6a, a cash out button 6b, a double up game start button 6c, a bet button for a double up game 6d, bet buttons for a slot game 7a, 7b, 7c, payline selection buttons 8a, 8b, 8c, a coin tray 9, and various types of lamps 10a and 10b. A monitor 11 is visible through the display window 4. Coins are discharged from a coin chute 9a, and then stored in the coin tray 9. The buttons 6a, 6b, 6c, 6d, 7a, 7b, 7c, 8a, 8b, and 8c are preferably mechanical lamp buttons including light emitting devices which emit light when pushed. Alternatively, the buttons may be virtual button images displayed on a touch panel mounted on the monitor 11.

The monitor 11 is placed inside the slot machine 1. The monitor 11 displays a column of various symbols arranged in a predetermined order, i.e., a video reel, on each of five symbol display areas 11a. The monitor 11 is preferably included in a liquid crystal display, or alternatively, may be included in a cathode-ray-tube display or a plasma display. The monitor 11 also displays a main credit display area 11b, a bet display area 11c, and a sub-credit display area 11d above the symbol display areas 11a. The total amount of money that a player has inserted into the coin slot 5a and the bill slot 5b is assigned to an amount of credits in main credit data, and is displayed on the credit display area 11b. The amount of bets that the player has placed by using the buttons 6c, 6d, 7a, 7b, 7c, 8a, 8b, and 8c is displayed on the bet display area 11c. The amount of credits in sub-credit data is displayed on the sub-credit display area 11d.

A coin counter, a coin acceptor, a coin payout device, and a speaker are installed inside the slot machine 1 (not shown in FIG. 2). The coin counter counts the amount of coins and bills inserted into the coin slot 5a and the bill slot 5b, respectively. The coin acceptor validates the coins and bills. The coin payout device includes a hopper, and can hold a large number of coins.

A reset switch 12 is provided on one side of the slot machine 1. The reset switch 12 preferably includes a keyhole, and is activated by the insertion of a specific key into the keyhole. The specific keys are preferably possessed by casino workers. Accordingly, players cannot operate the reset switch 12.

A card slot 13 and a sub-display unit 14 are mounted on an upper portion of the slot machine 1. A house card can be inserted into the card slot 13. The house card is a removable recording medium usable within the casino, and provided to each player who has, for example, registered at a reception desk of the casino. The house card stores data for identification of an individual player, i.e. a player ID. On the other hand, a management server installed in the casino stores personal information on each registered player that is linked to a player ID. The management server also stores the amount of credits for each player, which is equivalent to the amount of money that the player has entrusted to the casino in advance, and is linked to the corresponding player ID. The house card is used by the management server in order to keep track of the number of points that represents the amount of credits that the player has spent on games. The player can be provided with bonuses such as free accommodation coupons, depending on the total number of the points. The sub-display unit 14 displays the number of the points provided to the player. The house card is further used in order to allow the money that has been entrusted to the casino in advance to be used as credits in playing games on the slot machine 1 (details will be described below).

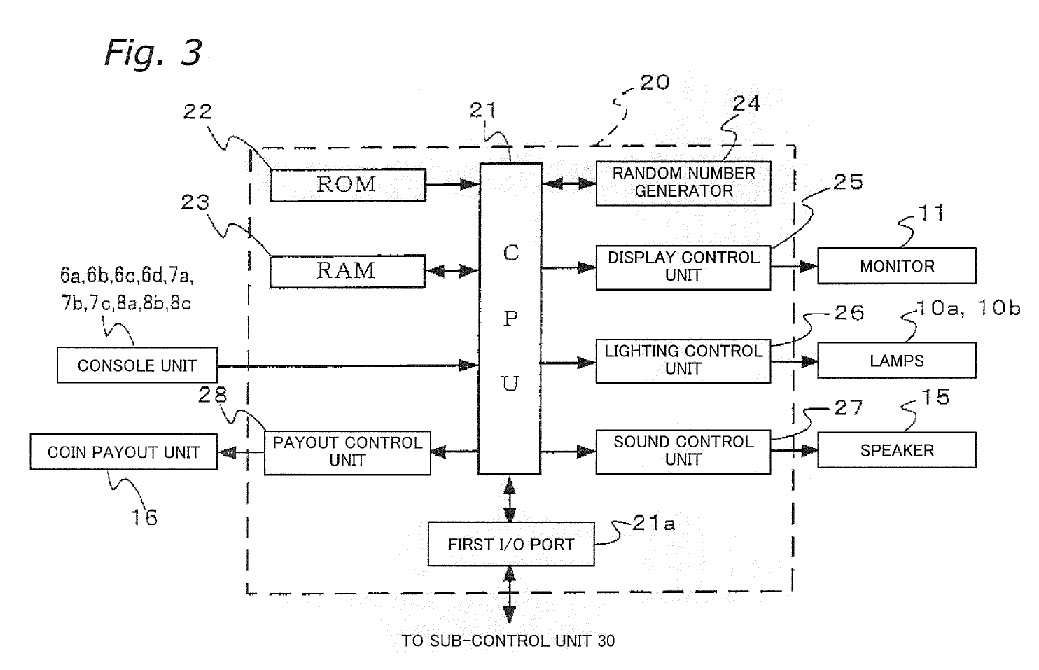

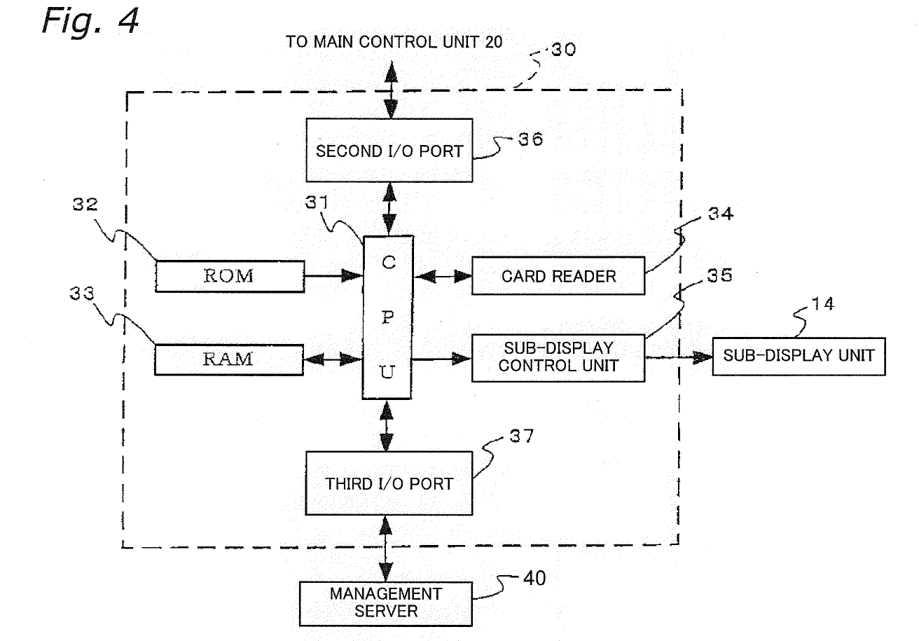

The slot machine 1 comprises a main controller unit 20 and a sub-controller unit 30 (cf FIGS. 3 and 4).

As shown in FIG. 3, the main controller unit 20 includes a first CPU 21, a first I/O port 21a, a first ROM 22, a first RAM 23, a random number generator 24, a display control unit 25, a lighting control unit 26, a sound control unit 27, and a payout control unit 28. The first I/O port 21a is used in data communication between the main controller unit 20 and the sub-controller unit 30. The first ROM 22 stores various programs and databases for use by the first CPU 21. The first RAM 23 temporally stores parameters computed by the first CPU 21. The first RAM 23 further serves as a credit memory unit, i.e., it stores two types of credit data: main credit data and sub-credit data. The random number generator 24 generates and provides random numbers to the first CPU 21 at regular intervals. The display control unit 25 controls display on the monitor 11 under the control of the first CPU 21. The lighting control unit 26 switches the lamps 10a and 10b on and off under the control of the first CPU 21. The sound control unit 27 controls the speaker 15 to reproduce voice announcements, sound effects, and the like, under the control of the first CPU 21. The payout control unit 28 controls the coin payout device 16, thereby supplying a proper amount of coins through the coin chute 9a to the coin tray 9 under the control of the first CPU 21.

The spin button 6a, the cash out button 6b, the double up start button 6c, the various bet buttons 6d, 7a, 7b, 7c, and the payline selection buttons 8a, 8b, and 8c constitutes a console unit, which is connected to the first CPU 21. Moreover, the coin counter and the coin acceptor is also connected to the first CPU 21 (not shown in the figures).

As shown in FIG. 4, the sub-controller unit 30 includes a second CPU 31, a second ROM 32, a second RAM 33, a card reader 34, a sub-display control unit 35, a second I/O port 36, and a third I/O port 37. The second ROM 32 stores various programs and databases for use by the second CPU 31. The second RAM 33 temporally stores parameters computed by the second CPU 31. The card reader 34 reads a player ID from the house card inserted into the card slot 13, and provides the player ID to the second CPU 31. The sub-display control unit 35 controls the sub-display unit 14 under the control of the second CPU 31. The second I/O port 36 is used in data communication between the main controller unit 20 and the sub-controller unit 30. The third I/O port 37 is used in data communication between the sub-control circuit board 30 and the management server 40 of the casino. Here, the management server 40 collectively controls a plurality of gaming machines in the casino, including the slot machine 1.

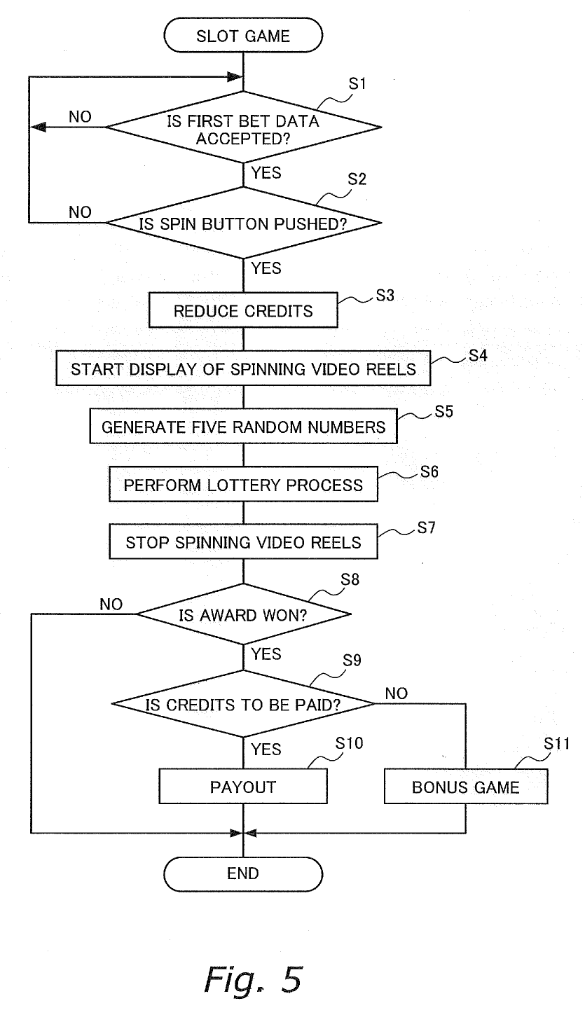

On the slot machine 1, a player can play two types of games; the first type is a normal slot game, and the second type is a double up game. At first, the operation of each unit of the slot machine 1 will be explained in the order of the flow of a slot game on the slot machine 1 (cf. FIG. 5).

A player inserts coins or bills into the coin slot 5a or the bill slot 5b, respectively. Then, the coin acceptor validates the coins and bills, and the coin counter counts the authorized coins and bills. The first CPU 21 of the main controller unit 20 reads the count of the coin counter, and updates main credit data stored in the first RAM 23 to increase the number of credits by the number corresponding to the count.

Alternatively, the player can add an amount of credits stored in the management server 40 to the amount of credits in the main credit data in the following steps. First, the player inserts a house card in which his/her own player ID is stored into the card slot 13. Then, the card reader 34 of the sub-control unit 30 reads the recorded player ID from the inserted house card, and sends the read player ID to the second CPU 31 of the sub-control unit 30. The second CPU 31 receives the player ID from the card reader 34, and determines whether the player ID is valid or not. Note that the management server 40 may perform the determination instead of the controller unit of the slot machine 1. In this case, the second CPU 31 sends the received player ID to the management server 40, and then receives the results of the determination from the management server 40 as a response to the player ID.

When the player ID is determined to be invalid, the second CPU 31 sends a signal representing the invalidity to the first CPU 21 of the main control unit 20. The first CPU 21 receives the signal, and then commands the display control unit 25 to display an error message on the monitor 11. On the other hand, the second CPU 31 commands the card reader 34 to discharge the house card from the card slot 13 by using a card discharge signal.

When the player ID is determined to be valid, the second CPU 31 sends a request for credit data linked to the player ID received from the card reader 34 to the management server 40 through the third I/O port 37. In response to the request, the management server 40 retrieves the credit data linked to the player ID from a database, and then sends the credit data to the slot machine 1. The third I/O port 37 of the sub-control unit 30 receives the credit data, and then the second CPU 31 transfers the credit data from the third I/O port 37 to the first CPU 21 of the main control unit 20. The first CPU 21 uses the received credit data to update the main credit data stored in the first RAM 23. Thus, the player can use the amount of credits stored in the management server 40 in playing games on the slot machine 1. In this case, players do not have to carry cash within the casino. This facilitates playing games in the casino.

The player can place a desired bet on a desired payline by using the console unit, in particular, the bet buttons 7a, 7b, 7c, and the payline selection buttons 8a, 8b, 8c (Step S1). The slot machine 1 comprises three paylines, and allows the player to selectively place 1-3 units of credits on each payline as a bet, for example. More specifically, the player selectively pushes the payline selection buttons 8a, 8b, 8c corresponding to the desired paylines. Next, the player selectively pushes the bet buttons 7a, 7b, and 7c corresponding to the desired bet, 1, 2, and 3 units of credits, respectively. The console unit accepts the bet placement operation, and sends data representing the contents of the operation (hereinafter, first bet data) to the first CPU 21 of the main controller unit 20. Then, the first CPU 21 changes its status to enable an operation signal from the spin button 6a, and thereby the player can cause the video reels to spin by using the spin button 6a.

The player pushes the spin button 6a (Step S2), and then the first CPU 21 of the main controller unit 20 functions as a credit processing unit, i.e., it updates the main credit data stored in the first RAM 23 to decrease the amount of the credits by the total amount of the bets represented by the first bet data (Step S3). For example, the player places the same amount (e.g., 2 units) of credits on each of the selected paylines (e.g., 3 paylines), and then the total amount of the bets is equal to the product of the number of the selected paylines and the amount of the credits per payline (e.g., 6 units of credits).

After that, the first CPU 21 functions as a start signal generator unit, i.e., it generates and sends a start signal to the display control unit 25. In response to the start signal, the display control unit 25 starts the display of spinning video reels, i.e., a continuous change in the symbols displayed on the five symbol display areas 11a of the monitor 11 (Step S4).

The first CPU 21 and the random number generator 24 functions as a lottery unit as follows. The first CPU 21 sends the start signal to the random number generator 24. In response to the start signal, the random number generator 24 generates five random numbers, and provides them in turn to the first CPU 21 (Step S5). Each of the five random numbers is assigned to a video reel displayed on one of the five symbol display areas 11a. The first CPU 21 accesses the first ROM 22, and compares the five random numbers with items in different tables (hereinafter, stop position tables). Each of the stop position tables is assigned to a video reel displayed on one of the five symbol display areas 11a, and represents a predetermined link between random numbers and symbols included in each video reel. The first CPU 21 then determines the stop positions of the video reels that represent symbols linked to the random numbers in the stop position tables. The symbols will be displayed on the five symbol display areas 11a as stopped video reels after the display of spinning video reels.

The first CPU 21 and the random number generator 24 also functions as an award processing unit, i.e., they decide whether or not to provide an award to the player under a lottery process as follows. The first CPU 21 accesses the first ROM 22, and compares the combination of the five random numbers with the items in a table (hereinafter, a winning combination table) that represents predetermined links between combinations of five random numbers and awards (Step S6). The awards are broadly divided into predetermined amounts of credits and rights to play a bonus game, i.e., a special game such as an event, a free game, a feature game, or the like. If there is an award linked to the combination of the five random numbers in the winning combination table, the first CPU 21 then determines to provide the award to the player. Note that the first ROM 22 stores two types of winning combination tables: the first type thereof is used in normal slot games, and the second type thereof is used in bonus games. Preferably, a first-type winning combination table is assigned to each payline.

After the lottery process, the first CPU 21 controls the display control unit 25 to change from the spinning video reels to the stopped video reels on the five symbol display areas 11a of the monitor 11 (Step S7). Thus, the symbols linked to the random numbers in the stop position tables are arranged on the five symbol display areas 11a.

If an amount of credits is to be provided to the player under the lottery process (Steps S8 and S9), the first CPU 21 will control visual and sound effects by providing the lighting control unit 26 and the sound control unit 27 with commands after the stopped video reels have been displayed on the symbol display areas 11a. The lighting control unit 26 then turns on and off the lamps 10a, 10b and the lamp buttons equipped with internal light emitting devices, such as the buttons 6a, 6b, 6c, 6d, 7a, 7b, 7c, 8a, 8b, and 8c, in the patterns represented by the commands. The sound control unit 27 changes sounds reproduced from the speaker 15 to the sound effects represented by the commands. After that, the first CPU 21 performs a payout procedure (Step S10). More specifically, the first CPU 21 functions as a payout processing unit, i.e., it updates the sub-credit data stored in the first RAM 23 to increase the credits by the amount to be provided as an award (Step S10).

If the right to play a bonus game is to be provided to the player under the lottery process (Steps S8 and S9), the first CPU 21 will first control visual and sound effects as described above. Next, the first CPU 21 will change from a slot game mode to a bonus game mode (Step S11). Then, the bonus game can proceed.

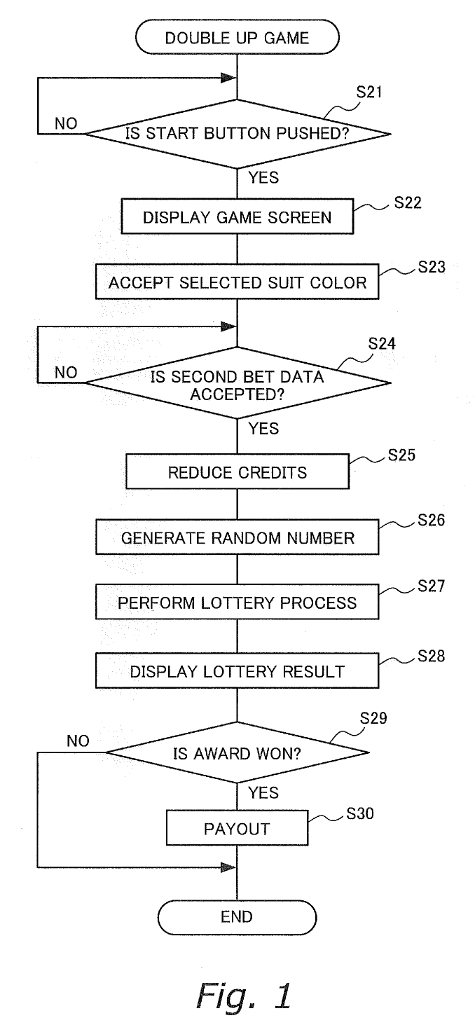

On the slot machine 1, a player can also play a double up game. The operation of each unit of the slot machine 1 will be explained in the order of the flow of a double up game (cf. FIG. 1). Here, a double up game is a game in which a player selects from two options and places a bet on the selected option, and depending on the selected option, the player will win credits two times as large as the bet, or lose the bet. In a double up game on the slot machine 1, for example, a player takes a guess on which of red (heart and diamond) and black (spade and club) suit cards is displayed in a face-down position on the monitor 11.

A player pushes the double up game start button 6c in an interval between rounds of a slot game, and then a double up game will start. More specifically, the double up game start button 6c is pushed (Step S21), and the console unit accepts the push and sends a start command to the first CPU 21 of the main controller unit 20. The first CPU 21 receives the start command, and then invokes a program for a double up game from the first ROM 22. The first CPU 21 further changes from a slot game screen (including, e.g., video reels) to a double up game screen (including, e.g., a face-down card image) on the monitor 11 (Step S22). After that, the first CPU 21 changes its status to enable an operation signal from the bet button for a double up game 6d, and thereby the player can put a bet on a double up game by using the bet button 6d.

The player first selects a red or black suit by using the payline selection buttons 8a, 8b, 8c (Step S23). Next, the player pushes the bet button 6d, and then the console unit accepts the selected suit color, and sends data representing the selected suit color (hereinafter, second bet data) to the first CPU 21 of the main controller unit 20 (Step S24). The first CPU 21 receives the second bet data, and functions as a credit processing unit, i.e., it updates sub-credit data stored in the first RAM 23 to decrease the amount of credits by an amount, which is assigned to a bet (Step S25). Preferably, the total amount of credits represented by the sub-credit data is assigned to a bet. In this case, the sub-credit data is reset at each round of a double up game. Alternatively, a constant amount or a percentage of the credits may be assigned to a bet. The slot machine 1 may allow a player to determine the amount of a bet freely.

The first CPU 21 and the random number generator 24 functions as a lottery unit as follows. At the reception of the second bet data, the first CPU 21 sends a request to the random number generator 24. In response to the request, the random number generator 24 generates a random number, and provides it to the first CPU 21 (Step S26). The random number is linked to one type of card in a deck of cards (52 types of cards) in a table (hereinafter, a deck table) stored in the first ROM 22. The first CPU 21 accesses the first ROM 22, and retrieves one type of card linked to the random number from the deck table (Step S27). Thus, one type of card is determined at random.

In the deck table, random numbers are uniformly linked to 52 types of cards. Accordingly, the probability that a type of card will be selected is the same between 52 types of cards. Therefore, the probability that the player will win is 50%. Since a winning player can be provided with an amount of credit two times as large as the amount of a bet, the payout percentage for the double up game is 100%. A player can statistically recover all credits that have been bet on the double up games. On the other hand, the payout percentage for the slot game is preferably lower than 100%, more preferably, set to be 90%. A player who bets 100 units of credits on the slot games will statistically lose 10 units of credits. Thus, the probability of increasing credits is higher in the double up game than the slot game.

After the lottery process, the first CPU 21 controls the display control unit 25 so as to turn the card image face up on the monitor 11 (Step S28). Then, a face-up card image of the type selected by the lottery process is displayed on the monitor 11.

If the suit color of the face-up card image matches the suit color selected by the player, the first CPU 21 will determine that the player has won (“Yes” in Step S29), and control specific visual and sound effects by providing the lighting control unit 26 and the sound control unit 27 with commands. After that, the first CPU 21 performs a payout procedure (Step S30). More specifically, the first CPU 21 functions as a payout processing unit, i.e., it updates the main credit data stored in the first RAM 23 to increase the credits by an amount two times as large as the bet put on the double up game.

As described above, the RAM 23 stores two types of credit data: the main credit data and the sub-credit data. The slot machine 1 allows a player to play two types of games: the slot game and the double up game. The player can play the slot game and the double up game by using the credits represented by the main credit data and the sub-credit data, respectively. Each time the player wins an amount of credits in the slot game, the slot machine 1 updates the sub-credit data in order to increase the amount of credits by the amount that has been won. Thus, the player can achieve a right to play the double up game when the player has won the slot game many times. Here, the amount of credits represented by the sub-credit data originates not in the money that the player has input in advance, but rather in the awards won as results of the slot game. This may reduce the player's fear of losing all his or her money in the double up game, and thereby cause the player to feel free to play the double up game. Thus, the slot machine 1 may induce the player to play the double up game, even if the double up game is more risky than the slot game, i.e., the double up game requires a larger amount of a bet per round than the slot game.

Furthermore, the slot machine 1 sets the payout percentage of the double up game to be 100%. Accordingly, a player who plays the double up game can recover all the credits used in the double up games on average. This reduces the risk of playing the double up games, and thus the slot machine 1 can induce players to play the double up game, even if the double up game is more risky than the slot game.

The slot machine 1 disables the shift of a portion of or all of the credits represented by the main credit data to credits represented by the sub-credit data, and thereby inhibit the use of credits represented by the main credit data as a bet in the double up game. A player who wants to play the double up game has to win credits in the slot game many times, and thereby increase the credits represented by the sub-credit data. Thus, the slot machine 1 can induce players who want to play the double up game only to play the slot game.

The console unit may accept an instruction from a player to shift a portion of or all of the credits represented by the sub-credit data to credits represented by the main credit data. For example, the player uses the buttons on the front panel 3 to enter the instruction. Thus, the player can play the slot game even if the player has used up the credits represented by the main credit data. In particular, the slot machine 1 requires the player only to push buttons for a shift of credits from the sub-credit data to the main credit data. This facilitates the shift. If the slot machine 1 does not accept the instruction, the player who needs the shift has to perform the following tedious steps: the player first uses the cash out button 6b to receive coins equivalent to the credits represented by the sub-credit data from the slot machine 1; and the player next will input a portion of or all of the coins into the coin slot 5a. By accepting the instruction, the slot machine 1 allows the player to skip the tedious steps, and thereby can enhance the players' willingness to play games thereon.

Each time a player wins an amount of credits as a result of the double up game, the slot machine 1 updates the main credit data to increase the amount of credits by the amount won in the double up game. In this case, the player can play the double up game in order to increase credits represented by the main credit data. Thus, the player can balance credits between the main credit data and the sub-credit data, and thereby enjoy the slot and double up games in balance.

Here, the slot machine 1 may update the sub-credit data in order to increase the amount of credits by the amount won in the double up game. In this case, the amount of the credits represented by the sub-credit data is the total number of credits won in the slot and double up games. Thus, the credits represented by the sub-credit data are easy to increase. This allows the slot machine 1 to induce players to play the double up game, even if it is more risky than the slot game. The slot machine 1 may update both the main and sub-credit data to increase the amount of credits by a portion and the remainder of the amount won in the double up game, respectively. Alternatively, the slot machine 1 may pay out coins, which are equivalent to a portion of or the entire amount won in the double up game, out of the coin chute 9a.

In the above-described embodiment, the present invention can be applied to the slot machine 1, but the first game may be a game different from the slot game. Similarly, the second game may be a game different from the double up game.

In the above-described embodiment, the console unit accepts a push of the double up game start button 6c and the second bet data independent of the status of the slot game. In that case, the first CPU 21 changes the slot game program in midstream to the double up game program when the console unit has accepted the second bet data in the period of the slot game (e.g., the interval between rounds). In particular, an entry of the second bet data may automatically change the slot game to the double up game. Thus, the slot machine 1 allows a player to play the double up game at a desired time, and thereby can attract the player. Alternatively, the slot machine 1 may determine the timing of the start of the double up game depending on the status of the slot game. For example, the double up game will start as a type of bonus game when a right to play the bonus game has been won in the slot game, or the double up game will start when an amount of credits has been won in the slot game.

### GENERAL INTERPRETATION OF TERMS

In understanding the scope of the present invention, the term “configured” as used herein to describe a component, section or portion of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single portion or a plurality of portions. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A gaming machine comprising:
a memory unit configured to store main credit data and sub-credit data;
a console unit configured to allow a player to enter one of first bet data and second bet data thereinto, the first bet data and the second bet data each representing an amount of a bet placed by the player;
a controller unit configured to execute a first game program and a second game program when the console unit has accepted the first bet data and the second bet data, respectively, and determine whether or not to provide the player with an amount of credits as a result of a first game and a second game conducted by the first game program and the second game program, respectively;
a display unit configured to display the main credit data, the sub-credit data, and a game screen depending on the status of the first game and the second game; and
a credit processing unit configured to
update the main credit data and the sub-credit data to reduce the amount of credits by the amount of a bet represented by the first bet data and the second bet data before the controller unit starts the first game and the second game, respectively, and
update the sub-credit data to increase the amount of credits by a predetermined amount each time the controller unit decides to provide an amount of credits as a result of the first game.

2. The gaming machine according to claim 1, wherein the credit processing unit is configured to disable the shift of a portion or all of the credits represented by the main credit data to credits represented by the sub-credit data, and thereby inhibit the use of credits represented by the main credit data as a bet in the second game.

3. The gaming machine according to claim 1, wherein
the console unit is configured to accept second bet data independent of the status of the first game; and
the controller unit is configured to change the first game program in midstream to the second game program when the console unit has accepted the second bet data during the first game.

4. The gaming machine according to claim 1, wherein the credit processing unit is configured to update the main credit data to increase the amount of credits by a predetermined amount each time the controller unit decides to provide an amount of credits as a result of the second game.

5. The gaming machine according to claim 1, wherein the credit processing unit is configured to update the sub-credit data to increase the amount of credits by a predetermined amount each time the controller unit decides to provide an amount of credits as a result of the second game.

6. The gaming machine according to claim 1, wherein
the console unit is configured to accept an instruction from a player to shift a portion of or all of the credits represented by the sub-credit data to credits represented by the main credit data; and
the credit processing unit is configured to
update the sub-credit data to reduce the amount of credits by an amount represented by the instruction that the console unit has accepted; and
update the main credit data to increase the amount of credits by the amount represented by the instruction.

7. The gaming machine according to claim 1, wherein the payout percentage of the second game is set to be 100%.
